(19) United States
(12) Patent Application Publication
(10) Pub. No.: US 2005/0151734 A1
(43) Pub. Date: Jul. 14, 2005

(54) Method and apparatus for rendering, storing and editing voxel objects

(76) Inventors: Andrew A. Gubkin, Yekaterinburg (RU); Denis S. Perevalov, Yekaterinburg (RU); Dmitry Y. Philonenko, Yekaterinburg (RU); Valery I. Sharin, Ekaterinburg (RU); Peter Novak, Fort Lauderdale, FL (US); Peter V. Zakrevsky, Yekaterinburg (RU)

Correspondence Address: AKERMAN SENTERFITT, P.O. BOX 3188, WEST PALM BEACH, FL, 33402-3188, US

(21) Appl. No.: 10/757,176

(22) Filed: Jan. 14, 2004

(51) Int. Cl. G06T 17/00

(52) U.S. Cl. 345/424

(57) ABSTRACT

A method of manipulating a voxel object includes the steps of selecting a voxel grid having a plurality of voxels, representing a 3D object in a first voxel space representation using at least a portion of the plurality of the voxels, and converting the first representation into a second voxel space representation. The second representation is defined by a plurality of boundary voxels representing a border of the 3D object and is exclusive of outer voxels, such as a matrix of segments representation which includes a plurality of spaced apart parallel line segments. The line segments are preferably compressed by eliminating inner and empty voxels of the 3D object. Manipulation of the voxel object can include direct creation, editing and rendering of 3D graphics objects.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The invention relates to computer graphics systems and 3D modeling, and more specifically, to voxel-based 3D object rendering, storing and editing.

### BACKGROUND OF THE INVENTION

Three-dimensional (3D) computer graphics have become essential for many modern world applications. Among the many applications for 3D graphic images are computer games, video and motion picture production, industrial product design, medical diagnostics and geophysical imaging, as well as visualization of results from physical modeling in physics and chemistry. Methods for generation, representation, storage, and rendering of 3D objects are emerging as the basis for computer graphics.

3D objects are structures that are stored in computer memory. The stored information reflects the shape and properties of the 3D objects in space. These 3D structures can be scanned images or models of real objects, or may represent shapes of non-real objects, such as those generated by computer design and modeling. 3D graphics systems allow for creation and editing of 3D objects, as well as display of their 2D representations on displays (e.g. computer screens) or in print form.

In conventional real-time 3D modeling, polygons are used to represent 3D objects. In this method, a 3D body is represented by its surface, which is defined by a plurality of polygons. Even though polygonal representations generally provide poor approximations for many real-world objects, polygons are presently widely used because of their relatively low computer processor and memory requirements. Unfortunately, polygonal representations are unrealistic for most real-world objects because of the smooth regularity imposed by polygon-based representations cannot account for imperfections and variations inherent in real-world forms. Polygons are equally deficient for modeling most scientific data. Real world data, such as derived from medical scans, for example, are more easily interpreted and understood when viewed in three dimensions. Thus, in many cases, polygon representations cannot provide a sufficient level of detail to allow best use of complex 3D images, especially for medical images.

As the use of 3D graphics becomes more popular, animators and artists are called upon to create an ever-increasing number of live animation characters for production of games, videos and animated features. Existing methods and systems for 3D model creation resembles that of CAD systems used in industrial product design. The process of creating models consists of assembling an object from simple basic geometric volume containing elements, such as cubes or spheres. These “building block” elements are commonly referred to as “primitives”. Models thus created usually represent a mathematically precise geometric body. As described above, however, this process often prevents the creation of objects that look alive, realistic or even artistic. Solutions represented by current 3D modeling systems to solve the problem of enlivening or animation 3D objects include distorting the shape of the initial object, and generating changes of different kinds in shape and surface textures.

Volume element or “voxel” representations provide a better way to represent 3D objects in computer graphics, such as true 3D objects. When voxel representations are used, every part of the object (not just the surface of the object) is divided into a plurality of volumetric structures, such as cubes, which are stored on a regular grid in 3D space, referred to as the voxel space. A detailed description of an object can represent a large number of voxels, and thus require a large amount of memory for storage of the representation. For example, assuming no compression, a 2D representation of a 100×100 pixel cube face require 10,000 pixels, while the voxel representation of that same 3D object would require 100×100×100, or 1 million voxels.

Large memory requirements have generally been the single biggest drawback to application of voxels. The method in which voxels are stored in computer memory affects how fast the objects can be edited and rendered, and is therefore an important aspect of voxel implementation. Available methods of voxel storage include the volume buffer, the octree, and the binary space-partitioning tree. The octree and binary space-partitioning tree can provide good compression for images which include large blocks of contiguous, homogeneous area.

As noted above, voxel-based methods for direct representation of objects are not widespread in current graphics tools or programs because of memory requirements and significant rendering time. However, voxel representations are finding increased use in high-end or high-value applications, such as medical imaging tomography where there is a need to examine the internal structure of 3D objects for which polymeric representations provide no internal insight. Voxels representations are also being employed for modeling and visualization of fog, smoke and fluid flows in animations.

### SUMMARY OF THE INVENTION

The invention comprises methods, apparatus and systems for direct creation, editing and rendering of volume-elaborated 3D objects represented by voxels. Objects are defined by a set of voxels, which are volumetric structures, such as small cubes or tetrahedrons, oriented on a rectangular grid in a 3D voxel space. According to the invention, 3D objects are represented in a representation which defines the 3D object only by its boundary voxels. This representation eliminates the step of checking all voxels in a voxel space to first identify non-empty and inner voxels before rendering the same. This highly efficient representation permits accelerated rendering of 3D objects created with the invention, on a computer screen or any other 2D array, e.g. usual 2D array in a computer memory.

In a preferred embodiment of the invention 3D objects are represented only by their boundary voxels in accordance with the “matrix of segments” which represents the 3D object using a plurality of spaced apart parallel line segments. The line segments can be compressed by eliminating inner and empty voxels of the 3D object. A conventional voxel representation of a voxel object in voxel space includes inner and boundary voxels to represent the inside and the surface of the 3D object, respectively, as well as voxels exterior to the 3D object (empty/uncolored voxels). The “matrix of segments” method representation of the voxel object does not include inner voxels (which would be invisible while drawing), nor zero voxels (e.g. uncolored). Thus, the matrix of segments is a packed boundary of the voxel object. As a result, the matrix of segments representation permits accelerated rendering of 3D objects.

Editing can be performed utilizing the operations of drawing, molding, coloring and erasing voxels. In one embodiment, the invention provides artists or designers the ability to draw objects directly in the 3D space instead of creating them from graphic primitives. The invention uses voxels over which the user has direct control.

A method of manipulating a voxel object comprises the steps of selecting a voxel grid comprising a plurality of voxels, representing a 3D object in a first voxel space representation comprising at least a portion of the plurality of voxels, and converting the first representation into a second voxel space representation. The second representation is defined by a plurality of boundary voxels representing a border of the 3D object. The second representation is exclusive of outer voxels which are disposed outside the boundary voxels. The second representation can comprise a matrix of segments including a plurality of spaced apart parallel line segments, and further comprise the step of compressing the plurality of lines segments by eliminating inner voxels of the 3D object. In one embodiment of the invention, each of the plurality of line segments are represented as a pair of integer numbers corresponding to a z-coordinate of the boundary voxels for each non zero voxel of an x-y plane in the first representation, where the line segments having a length corresponding to a distance between the boundary voxels. The matrix of segments can have the form of: Archive[x][y],0≦x<W,0≦y<H, where Archive[i][j]=Lineᵢⱼ.

The 3D object can be an artificial object whose attributes are defined by user defined external commands. The attributes can include position, dimensions and color. The method can further comprise the step of displaying an image of the voxel object on a display device directly from the matrix of segments representation, wherein no buffer is used. The method can include the step of storing the first and second representation in computer memory.

The method can include the step of dynamically modifying an image displayed on the display device, wherein the modifying includes modification of the matrix of segments. In this embodiment, the image can be written to a buffer for storage as a stored frame. A plurality of stored frames can be combined over a specific timeframe to produce an animated film. One frame can include images of a plurality of different objects each in arbitrary and modifiable positions.

A system for manipulating a voxel object comprises structure for representing or receiving a 3D object in a first voxel space representation comprising at least a portion of a plurality of voxels included in a voxel grid, and structure for converting the first representation into a second voxel space representation. The second representation is defined by boundary voxels representing a border of the 3D object. The second representation is exclusive of outer voxels. The second representation can comprise a matrix of segments including a plurality of spaced apart parallel line segments, each of the plurality of lines being compressed by having no inner voxels of the 3D object.

The system can include a user controlled voxel brush apparatus conmmunicably connected to the system for drawing and/or editing of the 3D voxel object on a display device. Editing can comprise simultaneously adding, deleting or changing a plurality of voxels. Editing can include at least one of altering a color of selected ones of the voxels, translation of the voxel object, rotation of the voxel object, and altering a size or shape of the voxel object. The voxel brush can provide structure for positioning the voxel object using a plane in 3D space, structure for positioning the voxel object using a 2D image of the 3D object, and structure for using at least one of cubic, spheric, elliptic, random and any other user defined templates to represent the voxel object. The voxel object can be directly rendered on the display device from the matrix of segments representation without use of a buffer.

### BRIEF DESCRIPTION OF THE DRAWINGS

FIG. 1 is an architectural block diagram of a 3D canvas system, along with typical external devices, according to an embodiment of the invention.

FIG. 2 illustrates a voxel segments array, which is a method of voxel object representation for rendering using the 3D Canvas System. The voxel segments array shown is a rectangular grid of elements, the elements being segment lines consisting of voxel segments.

FIG. 3 illustrates an exemplary user interface apparatus, which one way by which a user can interact with a 3D canvas system.

FIG. 4 illustrates a schematic of a “renderer” function, for receiving rotational signals from the user interface and rendering the voxel object line by line in accordance with the selected scheme for segment matrix traversal.

FIG. 5A illustrates an exemplary coordinate system for voxel space. The voxel space shown is based on a cubic space, where voxel objects are created and edited. The respective coordinate axes (x, y and z) intersect at the center of the cube.

FIG. 5B illustrates denotation of eight corner vertices of the voxel space used in the rendering algorithm. The vertices from the front side of the cube are indexed with 1, and from the back with 2.

FIG. 6A, 6B, 6C and 6D illustrate methods of segment matrix traversal. The starting point is marked in the figures with circles and the arrows show the direction of traversal.

FIG. 7 is a block diagram of the voxel brush apparatus intended for voxel object editing, and its connection with the user interface apparatus and voxel space.

FIG. 8 illustrates the a format for storing objects in memory.

FIG. 9 illustrates the types of data blocks comprising the data from the FIG. 8.

FIG. 10A illustrates the color-block from FIG. 9 structure having length of k+4 bytes.

FIG. 10B illustrates the color-block from FIG. 9 structure having length of 1 byte.

FIG. 11A illustrates the repeat-block structure from the FIG. 9 having length of 2 bytes.

FIG. 11B illustrates the repeat-block structure from the FIG. 9 having length of 3 bytes.

FIG. 11C illustrates the repeat-block structure from the FIG. 9 having length of 1 byte.

FIG. 12 is a block diagram of a file format manager system intended for reading and writing voxel objects on the storage device, and its connection with the voxel space.

FIG. 13(a) is a representation of a pyramid using a conventional voxel representation based on cubic grid of voxels, while FIG. 13(b) is a representation of the same pyramid using cubic voxels based on the matrix of segments representation according to the invention.

FIG. 14 shows a tetrahedral grid of voxels.

FIG. 15 is a representation of a pyramid using a tetrahedral grid of voxels based on the matrix of segments representation according to the invention.

### DETAILED DESCRIPTION OF THE INVENTION

The invention provides a method and apparatus for direct control over the creation, editing and rendering of voxel objects in 3D, such as for computer graphics or animation. The invention provides the user, such as an artist or designer, the ability to draw objects directly in 3D space instead of creating them from graphic primitives.

The invention is generally for use in the form of a computer program or software package, and is suitable for use with both new and existing computer systems. Since most existing graphic systems utilize polygonal objects for 3D representation, the present invention also includes methods for converting voxel objects to polygonal objects, and vice versa.

As noted above, rendering of 3D voxel objects is presently an operation that is both memory intensive and slow. Published works regarding applications of voxel graphics are primarily devoted to the problem of increasing rendering speed and reducing memory requirements for the representation of objects having interior features. Similarly to previous efforts, the present invention addresses ease of editing and rendering speed of 3D objects. However, the invention provides a new method for voxel object representation, the representations being suitable for highly efficient image rendering. The method is referred to herein as the “matrix of segments” method. This representation method differs from the current methods of representation as described below in a way that greatly facilitates creation, editing and rendering of voxel objects.

A conventional voxel space representation includes a large number of voxels. For example, a cubic space with 128 voxels per side contains 2,097,152 voxels. A typical object may contain 20-50 thousand voxels. Thus, the object itself is only a couple of per cent of the overall volume and most voxels in the voxel space are empty.

When using a conventional representation, all voxels of the cube must be checked to find boundary voxels of the object to render the object since there is no listing of boundary voxels provided. Thus, all voxels must be checked to render the object even though most voxels are empty voxels. Checking the whole cube is very slow, thus rendering using a conventional representation is accordingly very slow.

The matrix of segments method described herein identifies a list of boundary voxels which are used to represent and efficiently render 3D objects. Using the matrix method, empty voxels are eliminated and only colored voxels are considered, thus saving considerable computing time.

To edit the voxel object, the voxel space representation is generally used. However, for rendering the voxel object, the matrix of segments representation is used. Since objects are both generally rendered and edited using the invention, both the voxel space representation as well as the matrix of segments representation is preferably stored, such as in conventional computer memory.

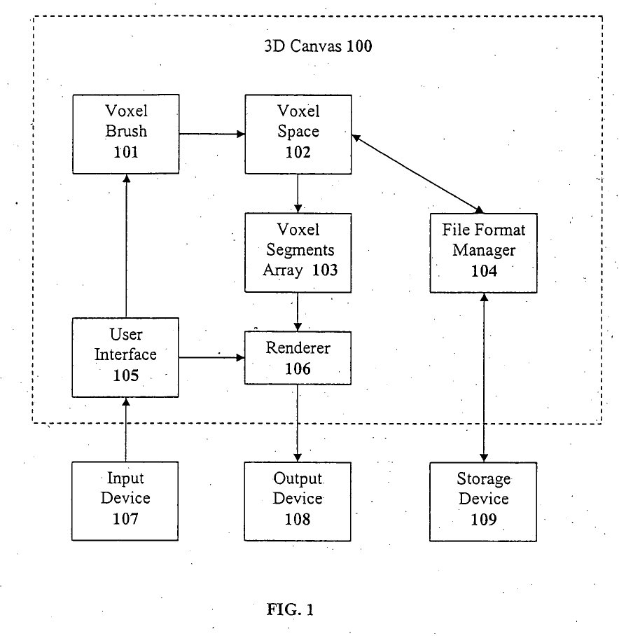

FIG. 1 depicts a schematic of an exemplary 3D voxel canvas system 100. The system 100 includes voxel space 102, which is a 3D voxel grid, in which the creation and editing of the voxel object takes place. This space 102 can be visualized as a plurality of volumetric structures, such as voxel cubes, in which a transversal plane is selected. This plane can be moved along the cube and helps to position a voxel brush 101.

The voxel brush 101 permits creation and editing of the voxel object in the voxel space 102. Brush control is provided by interface 105. A user passes control signals through the input device 107, which can be a keyboard, mouse or any other input device, including wired or wireless versions of the same. In one embodiment, voxel brush 101 can be visualized in system 100 near a mouse cursor 107, which is used for positioning the brush 101. The user is able to switch brush modes, which define the way the voxel objects are changed. The user can create new voxels as well as delete and repaint existing voxels with brush 101.

Voxel segments array 103 is based on the content of voxel space 102. The voxel segments array 103 is used for rapid voxel object rendering 106 on the output device 108. Any 2D array, for example, 2D computer memory array or a monitor display can serve as an output device 108 for system 100. In order to render a rotated voxel object, a traversal direction of segments array 103 can be selected. The traversal depends on the angles of rotation. Rendering generally proceeds by first rendering nearest voxels, then rendering the rest of the voxels in the turn from the first voxel. Thus, in this embodiment, the back voxels are rendered last.

The system interaction with external medium storage device 109 is carried out using file format manager 104. The hard drive of a computer or any other information-carrying medium, which supports working with files, can serve as storage device 109. File format manager 104 stores the representation of the voxel object, reads stored objects and converts voxel objects into polygonal objects and vice versa.

For efficient storage and rapid rendering of a 3D voxel object, voxel objects are represented as a “matrix of segments”. As noted above, the voxel space 102 is a grid that comprises a plurality of volumetric structures. The voxel grid can comprise cubic, tetrahedronal, hexagonal, other regular structures such as spheres, and even irregular structures. However, cubic and tetrahedronal structures are preferred as they do not create voids between adjacent structures, as well as increase compression and rendering efficiency compared to other structures.

Generally, there are many zeros (representing unfilled voxels) and inner voxels in a typical 3D voxel object stored in voxel space 102. Zeroes and inner voxels are redundant (unnecessary) information. It is desirable to store only information using only boundary voxels, since these are the only voxels that will actually be rendered.

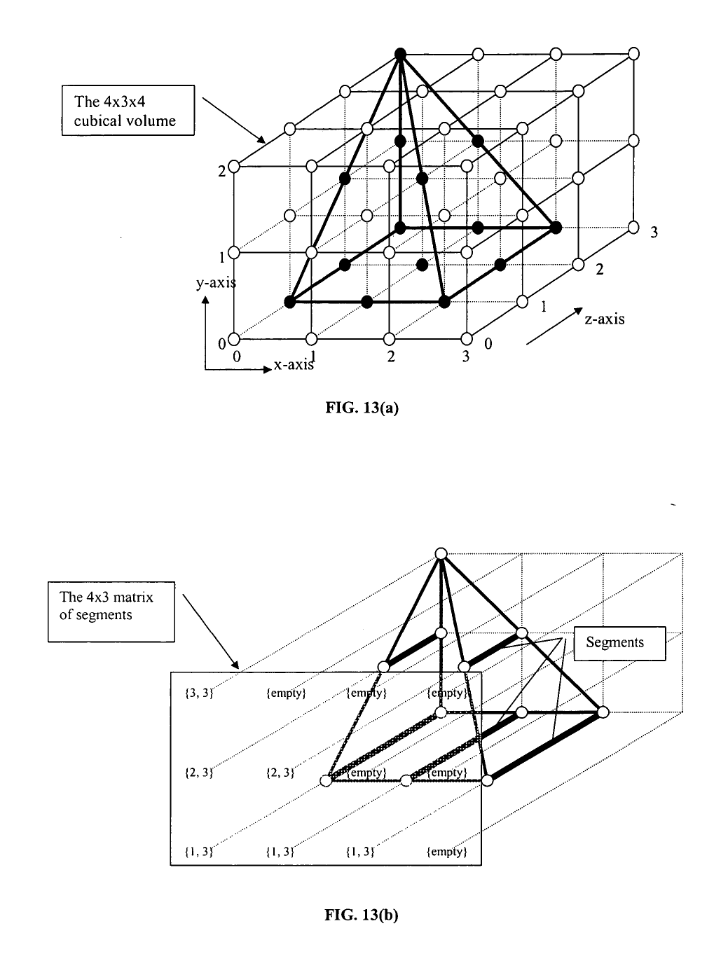

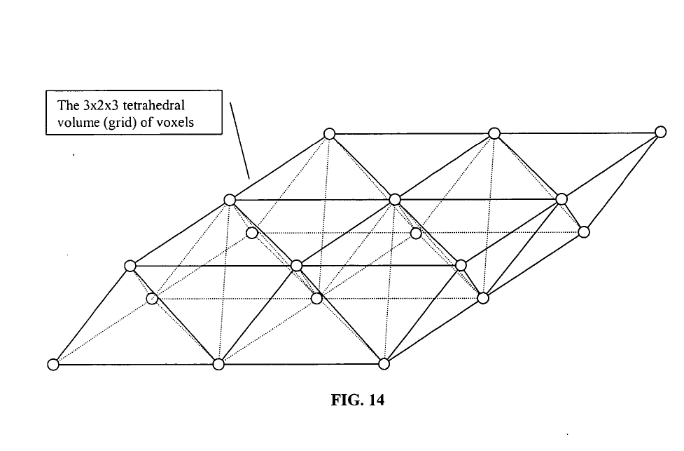

In a most preferred embodiment, cubes are the volumetric structures used. In this embodiment, a cubic voxel space having a volume n*n*n is first divided into n*n lines (segments) each having a length n. Each line is then compressed to remove empty and inner voxels. Segments having no filled voxels are also removed. The resulting matrix of segments is the set of those compressed lines. Thus, in every line (with coordinates i,j), non-zero voxels are packed into a structure referred to herein as Line_ij. The construction of Line_ij is described below. See also the Example section relating to FIGS. 13(a) and FIG. 13(b) for a comparison of a conventional voxel representation of a 3D object as compared to the matrix of segments approach according to the invention.

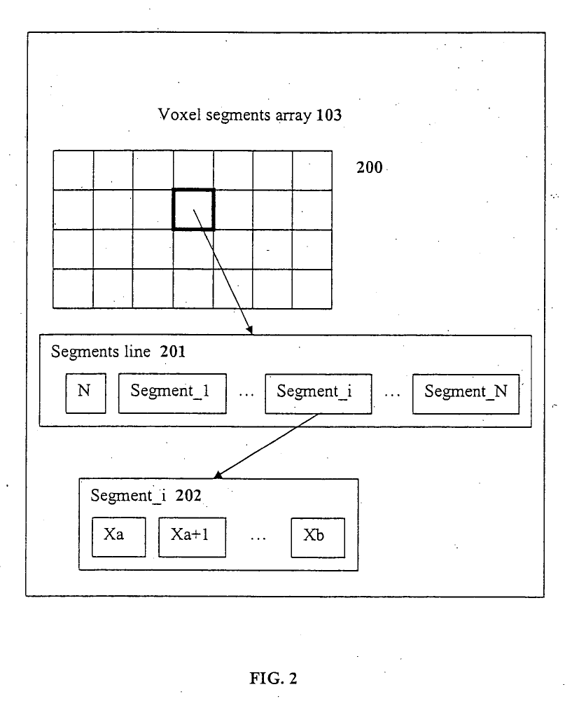

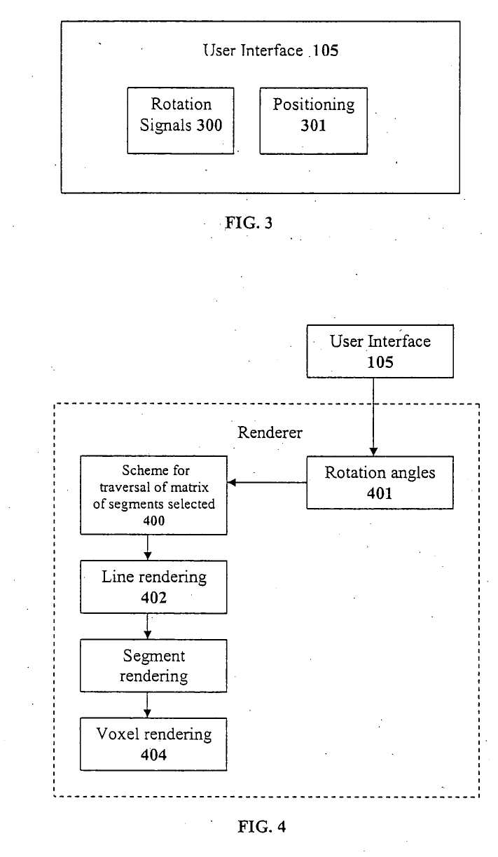

3D voxel objects can be represented only by its boundary voxels using a matrix of segments representation as depicted in FIG. 2. Let there be a sequence n,x₁, . . . ,xₙ. Consider x₀=xₙ₊₁=0. A segment is the subsequence xₐ, . . . ,x_{b}, such as xₐ₋₁=x_{b+1}=0 and for each a≦i≦b xᵢ≠0. Let [xₐ_{ᵢ},x_{b}_{ᵢ}], i=1, . . . ,N be all the segments of the sequence ordered on increase of xₐ_{ᵢ}.

The following structure is called a Line 201:
N,[a₁,b₁,xₐ_{₁}, . . . ,x_{b}_{₁}], . . . ,[a_{N},b_{N},xₐ_{_{N}}, . . . ,x_{b}_{_{N}}].

Let Space (voxel space) denote a three-dimensional grid 0≦x<W, 0≦y<H, 0≦z<L, where x, y, z, W, H, L are nonnegative integer numbers.

Let C be some set, which will be further called a color set. Let ƒ be a function defined on the Space and which has the values in C—color function.

Let the following structure be called a voxel voxel(x,y,z)=(x,y,z,ƒ(x,y,z)).

Let the following set be called a voxel object {voxel(x,y,z): ƒ(x,y,z)≠0}.

A voxel with coordinates (x, y, z) is called inner voxel, if (i) this voxel is not on the border of the Space (that is 0<x<W−1,0<y<H−1,0<z<L−1) and (ii) its neighbors belong to the voxel object (that is ƒ(x−1, y, z)≠0, ƒ(x+1, y, z)≠0, ƒ(x,y−1,z)≠0, ƒ(x,y+1,z)≠0, ƒ(x,y,z−1)≠0, ƒ(x,y,z+1)≠0. An inner voxel will be invisible in the drawn object, so it is not included in the matrix of segments representation. Consider the sequence A(i,j,z), 0≦z<L, where A(i,j,z)=voxel(i,j,z) if voxel(i,j,z) is not an inner voxel and is not a zero voxel. For inner or zero voxels A(i,j,z)=0. Let Lineᵢⱼ be the line which corresponds to this sequence. The following matrix 200 is called the representation of the voxel object Archive[x][y],0≦x<W,0≦y<H, where Archive[i][j]=Lineᵢⱼ (matrix of segments).

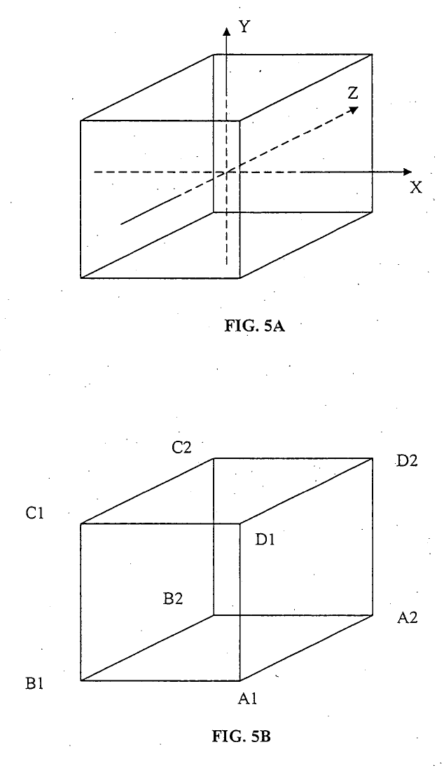

An exemplary order of processing for voxel objects is now described related to cubes. Let the X axis be defined by the equation {z=L/2, y=H/2}, Y axis with the equation {x=W/2, z=L/2}, and Z axis with equation {x=W/2, y=H/2}. Let the vertices of the cubes in the voxel space be denoted as follows: A1={x=W, y=0, z=0}, A2={x=W, y=0, z=L}, B1={x=0, y=0, z=0}, B2={x=0, y=0, z=L}, C1={x=0, y=H, z=0}, C2={x=0, y=H, z=L}, D1={x=W, y=H, z=0}, D2={x=W, y=H, z=L}, (See FIG. 5B).

Assume that the voxel space 102 is rotated by anglesα, β, γ around the axes X, Y, Z, respectively. It is found that the vertex after rotating has the minimal coordinate z−Vᵢ. The direction of the traversal of the voxel object representation is preferably chosen according to the value of V.

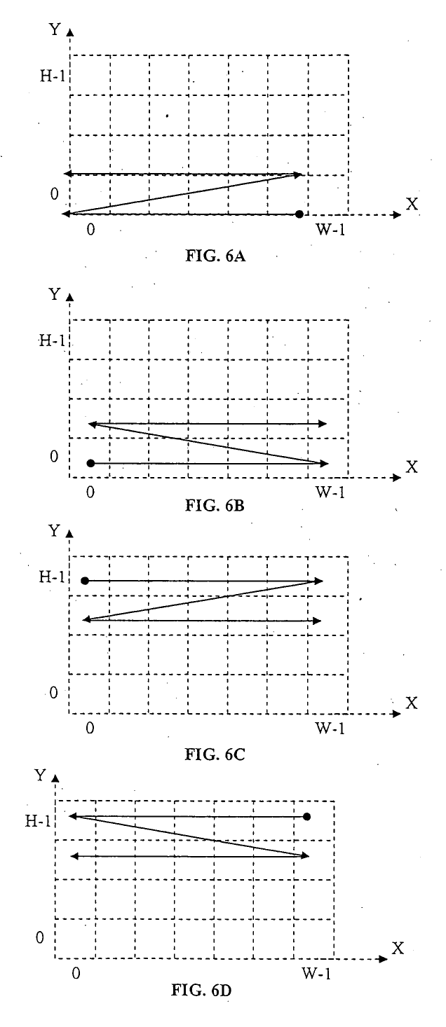

If V=A, the initial point of traversal is {X=W−1, Y=0}; FIG. 6A.

If V=B, the initial point of traversal is {X=0, Y=0}; FIG. 6B.

If V=C, the initial point of traversal is {X=0, Y=H−1}; FIG. 6C.

If V=D, the initial point of traversal is {X=W−1, Y=H−1}; FIG. 6D. All horizontal rows can be traversed in the direction indicated from the start point.

Voxel processing is now described. Let a procedure which obtains the voxel space and the values x, y, z as its parameters be called the “voxel handler” (for voxel(x,y,z) ). For segment processing, suppose there is a segment [xₐ,x_{b}]. Then, a direct order of processing dictates that the elements are processed in the order of xₐ, . . . ,x_{b}. In a reverse order of processing, elements are processes in the order x_{b}, . . . ,xₐ.

For line processing: If in the Vᵢ vertex i=1, process the segments of the line in the order [a₁,b₁,xₐ_{_{N}}, . . . ,x_{b}_{_{N}}], . . . ,[a_{N},b_{N},xₐ_{_{N}}, . . . ,x_{b}_{_{N}}], each segment is processed in the direct order. If in the Vᵢ vertex i=2, process the segments of the line in the order of [a_{N},b_{N},xₐ_{_{N}}, . . . ,x_{b}_{_{N}}], . . . ,[a₁,b₁,xₐ_{ᵢ}, . . . ,x_{b}_{ᵢ}], each segment is processed in the reverse order.

A basic method for voxel object rendering is now described: The basic rendering method is a processing of the voxel object with the following voxel handler: Point (x,y,z) is rotated by anglesα, β, γ about axes X, Y, Z to obtain point (x′,y′,z′). A pair of numbers (x′,y′) is sent onto the output device, the z′ coordinate is used for the interaction with z-buffer.

Voxel object rendering can be provided with dynamic effects. Rendering with dynamic effects is a voxel object processing with the following voxel handler. Point (x,y,z) is rotated by anglesα, β, γ about axes X, Y, Z to obtain point (x′,y′,z′). A pair of numbers (x′,y′) is sent to the output device and the z′ coordinate is used for the interaction with z-buffer. In addition, there is a certain graphic element that depends on parameters (x′,y′,z′). It is rendered along with the voxel and is related to each voxel. An alternative method for object rendering is to use the basic method of rendering described above, wherein each voxel is drawn as a disk.

A method for transparent voxel object rendering is now described. For rendering transparent voxels, the basic method of rendering is used. The color of each point can be a linear combination of the voxel color and the color of the point at which the voxel is being painted.

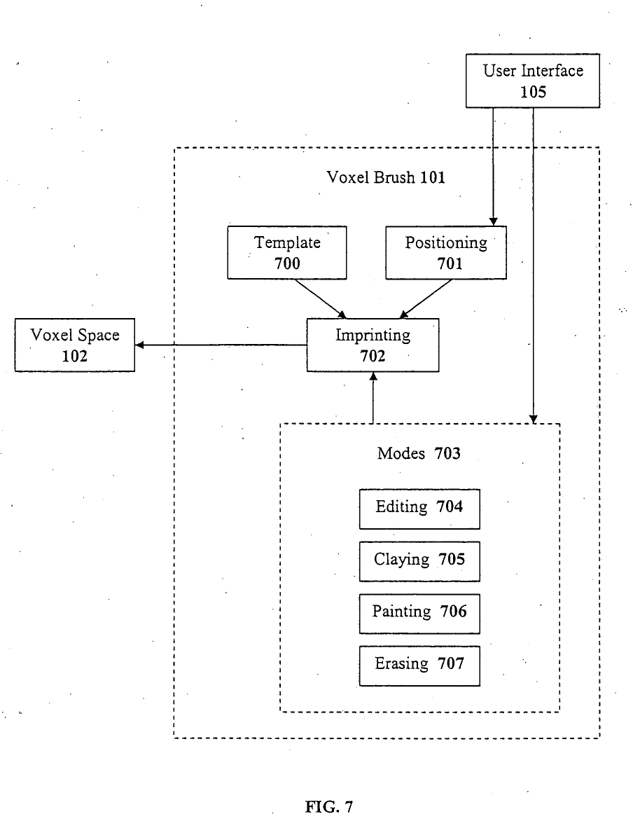

FIG. 7 depicts a schematic voxel brush 101. Voxel brush 101 is software-based instrument for editing the 3D voxel object. It consists of a template 700, a method of positioning 701, a method of imprinting 702 and a mode switcher 703.

The voxel brush instrument 101 allows drawing and editing of the voxel object which is situated in voxel space 102. Editing of the voxel object includes adding and deleting voxels to/from voxel space 102 and/or by changing existing voxels (e.g. colored to uncolored). In contrast to most voxel editors which constrain voxel object editing to adding and deleting a single voxel at a time, voxel brush 101 permits changing, adding and/or deleting of a plurality of voxels essentially instantaneously. Voxel brush 101 has dimensions, including a radius, and depth measured in one or more voxels, such as 1, 2, . . . , 100, or any other size. In contrast, available voxel editor brushes do not have dimensions, as they are just one voxel in size. If the brush 101 is positioned at the voxel(x,y,z) and brush 101 is used there, then all the voxels covered by brush, are modified, such as colored or deleted. See also the description of template 700 and method of imprinting 702, described in paragraphs 00069, 00070, 00075.

As noted above, the plurality of voxels filling the voxel space can be cubic, spherical or other shapes. The method described above clearly accelerates the process of creating a voxel model and enables actually drawing it in a 3D space. Thus, the voxel brush 101 can be regarded as a three-dimensional brush.

The shape and color of the brush 101 can be stored in a voxel template and be set by the operator. The voxel template itself represents a voxel object with a fixed voxel V₀ referred herein as an origin voxel.

The process of editing a voxel object representation of a 3D object in voxel space 102 using voxel brush 101 can include the following steps A and B:

A. Selecting a voxel brush position (X, Y, Z) in voxel space 102. This is supported using a positioning algorithm. There are two preferred positioning methods using voxel brush 101.

The first method involves positioning using a plane in the three-dimensional space. In this method, an operator sets a plane in voxel space 102 using input device 107 (e.g. a mouse) and then selects a point on this plane. For example, if the operator sets a plane parallel to the coordinate axis OX and OY, its equation is written as: z=Z. Then a point of this plane can be written as (X, Y). In this case the result obtained is that of positioning a three-dimensional point with coordinates (X, Y, Z).

The second method involves positioning using a two-dimensional image of an object. The operator selects a point on a rendered two-dimensional image of a 3D object. Coordinates of a voxel which was rendered in the given point is a result of the positioning.

To change voxel space the center V₀ of the voxel template is shifted to point (X, Y, Z) obtained by positioning. After that, a process of imprinting is carried out comprising changing voxels about the point (X, Y, Z) in accordance with the plurality of voxels set by the template. The modification is defined by the current voxel brush mode, the brush mode being set by the operator.

A voxel template is a voxel object, in which one voxel V₀, referred to herein as the origin voxel, is fixed. The template shape is chosen by the user, and can be of one of the following types:
1. Cubic;
2. Spheric;
3. Elliptic;
4. Random.

The user can define the color of template's voxels. It can be uniform, when all voxels are of the same color, or non-uniform when the voxels are of different colors, or random when the color of each voxel is defined randomly, such as on the basis of random number provided by a random numbers generator.

A method of positioning is a structure which permits a user to define the position of a voxel in 3D space. Positioning is processed using the 2D image of the voxel space and the object.

Positioning can be performed using a plane in 3D space: This type of positioning uses a plane in 3D space and has two stages:
1) definition of a certain plane by the user, and
2) selection of a point on the image of the plane by the user. This point, which is regarded as a point in space, is then the basis for the positioning.

Regarding positioning with the help of 2D image of the object, a user can select a point on the 2D image of the object. The object's voxel, to which the user has pointed, is the basis for positioning. Returning to the voxel brush, there are four basic modes that can be set by the user using the user interface 105 to operate the mode switcher 703, as depicted in FIG. 7.
1. Editing 704: In this mode an operator positions the brush with the help of a plane;

new voxels corresponding to the template are added.
2. Claying 705: Positioning is processed over the 2D image of an object; new voxels corresponding to the template are added.
3) Painting 706: Positioning is processed over the 2D image of an object; new voxels are not added but existing voxels are re-colored according to the template.
4) Eraser 707: Positioning is processed with the help of a plane or over the 2D image; voxels are deleted according to the template.

Imprinting can be performed in 3D-space. Imprinting 702 is a method for changing the voxels of voxel space 102 with respect to a point on the coordinates, defined in the positioning structure 701. Voxels to be added can be defined by the template according to the formula V[x0+x, y0+y, z0+z]=T[X0+x, Y0+y, Z0+z], for each (x, y, z) such that the voxel of the template T[X0+x, Y0+y, Z0+z] is not equal to 0,
wherein V is the voxel space 102,
   T is the template (700),
   (x0, y0, z0) are the coordinates of a voxel obtained as a result of positioning, and
   (X0, Y0, Z0) are the coordinates of the origin voxel V0.

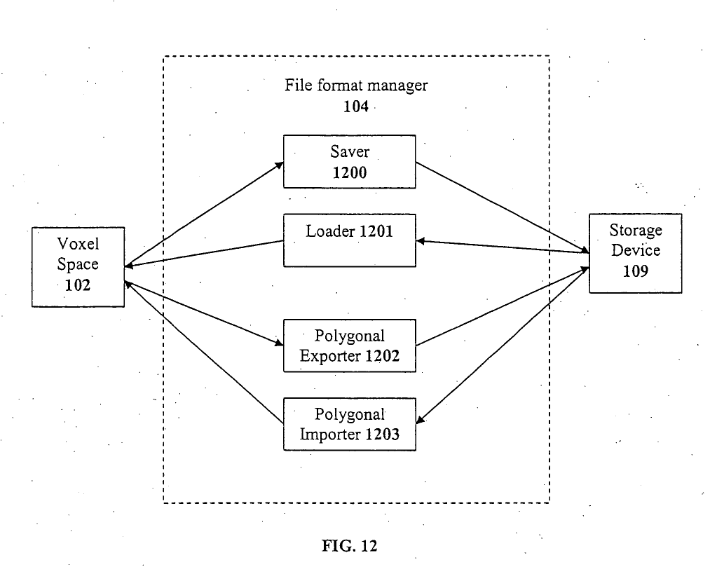

FIG. 12 depicts a file format manager 104. The file format manager writes and loads voxel objects from the storage device 109 to the voxel space 102. The file format manager 104 includes saver 1200 which writes a voxel object onto the storage device 109, and the loader 1201 which reads the object in a special file format for storage of the voxel object. The polygonal exporter block 1202 converts a voxel object into polygons and writes the polygonal representation onto the storage device 109. The polygonal importer block 1203 imports a polygonal object from the storage device 109 into the voxel space 102. Conversion of polygons into a voxel space representation is described below.

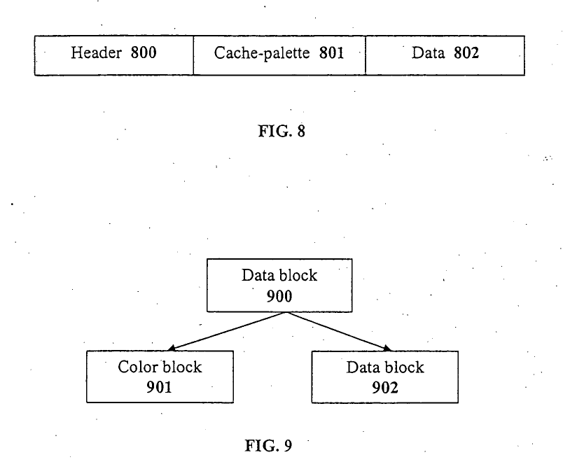

The invention also includes a file format for storing voxel objects. Such objects are located in a voxel parallelepiped with dimensions W×H×L. Each voxel has RGBA color and additional information which requires k bytes. This information can include normals and other properties. FIG. 8 depicts the file format for storage of voxel data. The Header 800 includes W, H, L, k and can contain additional information, such as the name of the object, date of creation, and the author.

The Cache-palette 801 is an array that contains the color parameter information for the voxels. This palette generally has a comparatively small size and stores the most frequently used sets of voxels' color parameters for a given object. An exemplary cache palette format is as follows:
two bytes specifying the integer number N−the number of records in the palette;
N blocks, 4+k bytes each describing the palette's components.

Data 802 is a set of data blocks describing the component voxels of an object. The number of blocks depends on the particular object. Data blocks can be of two types: color-block 901 and data-block (also referred to as repeat block) 902, as shown in FIG. 9. Color blocks encode parameters of voxels. Data blocks encode an integer number. The type of the block and its length can be defined by the value of the first byte of the block.

For example, consider the first byte as a sequence of eight (8) bits;
a7 a6 a5 a4 a3 a2 a1 a0
(CB1) if a7=0, then this block is a color block, and it has length 4+k byte, FIG. 10A. In bits a6 a5 a4 a3 a2 a1 a0 of the first byte the component A is stored, then the bytes R, G, B follow, as does the k byte block with additional information on the voxel.

(CB2) if a7=1, a6=0, then this block is a color block, and it has length 1 byte, as shown in FIG. 10B. Bits a5 a4 a3 a2 a0 store an index in the cache palette. If a7=1, a6=1, then it is a repeat-block.

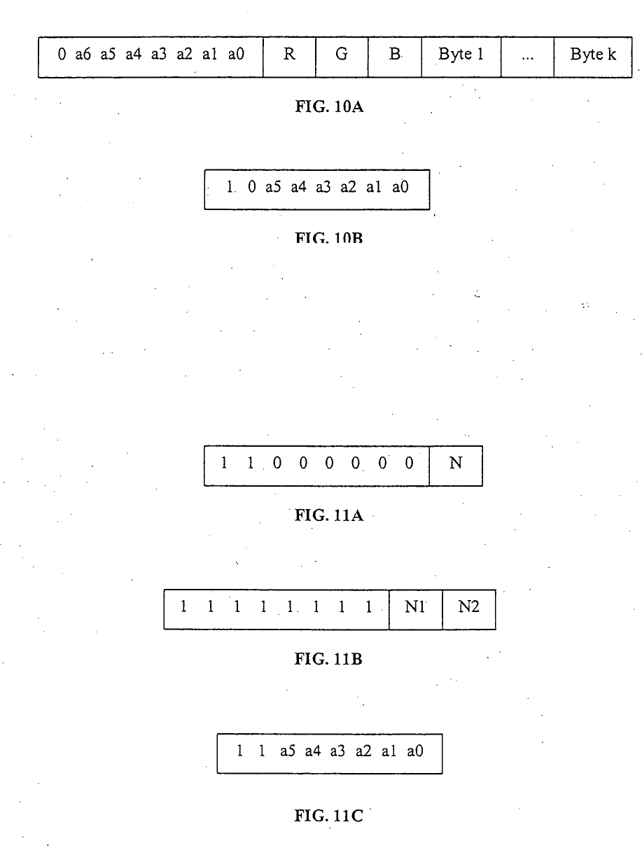

(RB1) If a5=a4=a3=a2=a1=a0=0, then the block has size 2, and the second byte stores an integer number from 63 to 255, as shown in FIG. 11A.

(RB2) If a5=a4=a3=a2=a1=a0=1, then the block has length 3, in the second and third bytes an integer number from 256 to 65535 is stored, as in FIG. 11B.

(RB3) If bits a5, a4, a3, a2, a1, a0 are not equal to 0 or 1 simultaneously, then the block has length 1, and bits a5 a4 a3 a2 a1 a0 store an integer number from 1 to 62, as shown in FIG. 11C.

Regarding data generation, if all voxels of the voxel parallelepiped in which the object is situated are numbered by the formula NUM=Z+Y*L+X*L*H, for example, wherein (X, Y, Z) are voxel's coordinates, (W, H, L) are dimensions of the voxel cube, then NUM is a resulting number of the voxel. The information on color parameters for the voxel is then written in the order of their numeration in a color block. If several voxels following one by one have the same color parameters, they are encoded with two blocks: namely the color-block, which defines the color parameter, and a repeat block, which defines the number equal to the number of repeating voxels minus 1. If a certain color is not in the palette, it is encoded with color-block of (CB1) type, otherwise it is encoded with a color block of the (CB2) type.

The invention also includes a method for conversion of a polygonal object into a voxel object according to the invention. In this case the input data is generally in the form of a set of triangles. These triangles are required to build a voxel object, the shape of which resembles the body formed from the triangles. The steps of the method are the following:
1. The body formed from the triangles is placed into a voxel parallelepiped with dimensions defined by a user.
2. If the center of the voxel is situated at a distance less than 0.5 from any triangle, this voxel is added to the object. Regarding the distance of 0.5, the voxel space is a grid with integer coordinates, thus the center of each voxel has 3 coordinates, not integer coordinates, but with floating point coordinates. For example, voxel(x,y,z) has a center with coordinates (x+0.5,y+0.5,z+0.5) ((x,y,z)−coordinates of one corner of the voxel, (x+1,y+1,z+1)−coordinates of the opposite corner and also coordinates of the corner of voxel(x+1,y+1,z+1). Coordinates of the center are the mean values−(x+0.5,y+0.5,z+0.5). A triangle is a figure in the 3D space. Then the 0.5 distance is the distance between the center of the voxel and the triangle figure in the usual mathematical sense.

If a polygonal object has been constructed with polygons other than triangles, each polygon is triangulated before applying the method. Methods of triangulating polygons are well known and based on standard mathematical procedures.

The invention includes a method for conversion of a voxel object according to the invention into a polygonal object. In this case the input data is a set of voxels regardless of position. The requirement is to build a set of polygons in the space, which form an object which approximates the surface of the initial 3D voxel object. To accomplish this:
1. Each voxel can be replaced with a point representing its center.
2. Spare directions for each non-zero voxel are found. A spare direction is a direction with respect to the voxel, in which the next voxel is empty.
3. For each cube of dimensions 2×2×2 in the voxel parallelepiped, non-empty voxels and their spare faces are analyzed. If while reviewing the cube from the top, bottom, left, right, front or from behind, at least three or four voxels have visible spare direction, then the voxel is deemed to be visible from the surface and the corresponding triangle or quadrangle is saved representing on the point centers of voxels.
4. All triangles and quadrangles taken without repetition are selected and then exported.

The rapid rendering features provided by the invention are well suited for applications including video games and animated films, architectural projection, educational purposes, development of 3D-imagination, and many others. With regard to creation of 3D animated films spanning a specific timeframe, the following two types of 3D transformations can be used with the invention:
i) In the case of relatively simple transformations which involve movement of the object(s), translation and rotation, the matrix segments representation can remain unchanged. Such manipulations are preferably performed by transforming voxel object orientation. Simple object transformations can be also carried out in both polygonal and voxel representations. In the case of the polygonal representation, the transformation function is applied to the vertices comprising the surface image of the object. In the case of the voxel objects, the same transformation function is applied to each voxel. In other words, the coordinates of the vertices or the coordinates of voxels are multiplied by a geometrical transformation matrix. The resulting image is then preferably written to a buffer before display on a suitable screen.
ii) In the case of a more complex transformation involving one or more voxel objects, an additional step is required wherein modification of matrix segments is used. Such modification may consists of an increase or decrease in the size of the segments matrix, as well as the content of the individual matrix elements, such as the number and positions of the segments in the matrix cells modifications are performed in the voxel space, and after finishing the modifications a new matrix representation is constructed.

For animation applications, the voxel space contents is not generally stored in memory, since the matrices comprising the matrix of segments representation is what is preferably stored when animated objects are transformed, voxel spaces are generated from the matrices, objects are transformed, then the revised matrix representation is generated.

### EXAMPLES

It should be understood that the examples and embodiments described herein are for illustrative purposes only and that various modifications or changes in light thereof will be suggested to persons skilled in the art and are to be included within the spirit and purview of this application. The invention can take other specific forms without departing from the spirit or essential attributes thereof.

### Example 1

### Representation of a Pyramid Using a Conventional Voxel Representation and a Representation of the Same Pyramid Using the Matrix of Segments Method According to the Invention

FIG. 13(a) shows an example of a conventional cubic voxel representation of an exemplary 3D-object, the object being a pyramid. A 4×3×4 (x, y, z) cubical volume of voxels is used. The pyramid is represented by voxels as shown therein, with black voxel vertices defining the pyramid, with white voxel vertexes being empty.

FIG. 13(b) shows the same pyramid as shown in FIG. 13(a), except now represented using a 4×3 matrix of segments according to the invention. Each of the segments shown are represented as a pair of integer numbers having a length corresponding to the difference in the z-coordinate of the first and last voxels shown above for each of the twelve (12) voxels on the x-y plane (4×3) which include at least one colored voxel in their respective z-dimensions. A total of six (6) segments thus can be used to represent the pyramid. The apex of the pyramid is a segment formed from a single voxel {3, 3}, while the other segments are formed from at least two voxels.

### Example 2

### Tetrahedral Volume Representation

The tetrahedral volume representation according to the invention does not complicate representation and rendering significantly as compared to a cubic representation. The only added difficulty is correctly choosing segments in the regular tetrahedral grid of voxels. FIG. 14 shows a 3×2×3 tetrahedral volume (grid) of voxels.

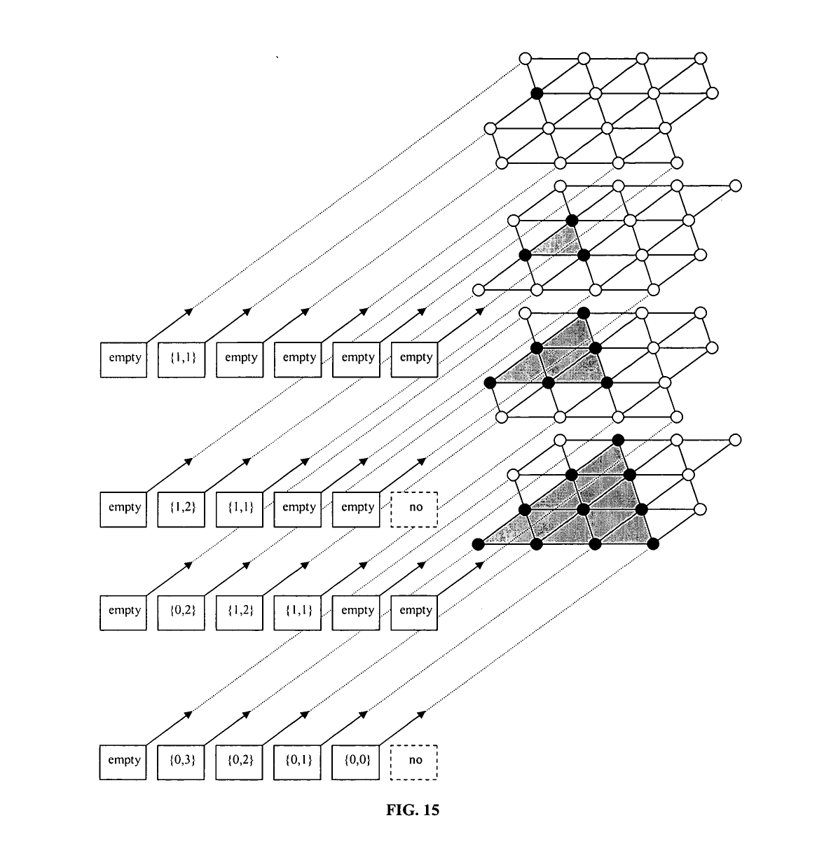

FIG. 15 shows a representation of a pyramid using a tetrahedral grid of voxels, together with a matrix of segments representation according to the invention shown in the left portion of the FIG. The pyramid is represented by a 4×4×4 tetrahedral volume of voxels. Four layers of tetrahedral grid of voxels are drawn without vertical edges. Black circles represent pyramid voxel vertices, while the white voxel vertices are empty. A 6×4 matrix of segments representation is shown in the left part of FIG. 15 to represent the pyramid, with only ten (10) segments being non-zero.

While various embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

1. A method of manipulating a voxel object, comprising the steps of:
selecting a voxel grid comprising a plurality of voxels;
representing a 3D object in a first voxel space representation comprising at least a portion of said plurality of voxels, and
converting said first representation into a second voxel space representation, said second representation defined by a plurality of boundary voxels representing a border of said 3D object, wherein said second representation is exclusive of outer voxels, said outer voxels disposed outside said boundary voxels.

2. The method of claim 1, wherein said second representation comprises a matrix of segments including a plurality of spaced apart parallel line segments, further comprising the step of compressing said plurality of line segments by eliminating inner voxels of said 3D object, said inner voxels disposed inside said boundary voxels.

3. The method of claim 2, wherein each of said plurality of line segments are represented as a pair of integer numbers corresponding to a z-coordinate of said boundary voxels for each non zero voxel of an x-y plane in said first representation, said segments having a length corresponding to a distance between said boundary voxels.

4. The method of claim 2, wherein said matrix of segments has the form Archive[x][y],0≦x<W,0≦y<H, where Archive[i][j]=Lineᵢⱼ.

5. The method of claim 1, wherein said 3D object is an artificial object, further comprising the step of defining attributes of said 3D object using user defined external commands.

6. The method of claim 5, wherein said attributes comprise position, dimensions and color.

7. The method of claim 2, further comprising the step of displaying an image of said voxel object on a display device directly from said matrix of segments representation, wherein no buffer is used.

8. The method of claim 1, further comprising the step of storing said first and said second representation in computer memory.

9. The method of claim 7, further comprising the step of dynamically modifying an image displayed on said display device, wherein said modifying includes modification of said matrix of segments.

10. The method of claim 9, further comprising the step of writing said image to a buffer for storage as a stored frame.

11. The method of claim 10, wherein a plurality of said stored frames are combined over a specific timeframe to produce an animated film.

12. A machine readable storage having stored thereon a computer program for manipulating a voxel object, said computer program comprising a routine set of instructions for causing the machine to perform the steps of:
selecting a voxel grid comprising a plurality of voxels;
representing a 3D object in a first voxel space representation comprising at least a portion of said plurality of voxels, and
converting said first representation into a second voxel space representation, wherein said second representation is defined by boundary voxels representing a border of said 3D object, said second representation being exclusive of outer voxels, said outer voxels disposed outside said boundary voxels.

13. The machine readable storage of claim 12, wherein said second representation comprises a matrix of segments including a plurality of spaced apart parallel line segments, further comprising the step of compressing said plurality of line segments by eliminating inner voxels of said 3D object, said inner voxels disposed inside said boundary voxels.

14. The machine readable storage of claim 13, wherein each of said plurality of line segments are represented as a pair of integer numbers corresponding to a z-coordinate of said boundary voxels for each non zero pixel of an x-y plane in said first representation, said segments having a length corresponding to the distance between said boundary voxels.

15. The machine readable storage of claim 14, wherein said matrix of segments has the form Archive[x][y],0≦x<W,0≦y<H, where Archive[i][j]=Lineᵢⱼ.

16. A system for manipulating a voxel object, comprising:
structure for representing or receiving a 3D object in a first voxel space representation comprising at least a portion of a plurality of voxels included in a voxel grid; and
structure for converting said first representation into a second voxel space representation, wherein said second representation is defined by boundary voxels representing a border of said 3D object, said second representation being exclusive of outer voxels, said outer voxels disposed outside said boundary voxels.

17. The system of claim 16, wherein said second representation comprises a matrix of segments including a plurality of spaced apart parallel line segments, each of said plurality of line segments being compressed having no inner voxels of said 3D object, said inner voxels disposed inside said boundary voxels.

18. The system of claim 17, wherein each of said plurality of line segments are represented as a pair of integer numbers corresponding to a z-coordinate of said boundary voxels for each non zero pixel of an x-y plane in said first representation, said segments having a length corresponding to the distance between said boundary voxels.

19. The system of claim 17, further comprising a user controlled voxel brush apparatus communicably connected to said system, said voxel brush for editing of said voxel object on a display device.

20. The system of claim 19, wherein said editing comprises simultaneously adding, deleting or changing a plurality of said voxels.

21. The system of claim 19, wherein said editing includes at least one of altering a color of selected ones of said voxels, translation of said voxel object, rotation of said voxel object, and altering a size or shape of said voxel object.

22. The system of claim 19, wherein said voxel object is directly rendered on said display device from said matrix of segments, wherein no buffer is used.

23. The system of claim 19, wherein said voxel brush provides at least one selected from the group consisting of structure for positioning said voxel object using a plane in 3D space, structure for positioning said voxel object using a 2D image of said 3D object, and structure for using at least one of cubic, spheric, elliptic, and random templates to represent said voxel object.
